(19) United States
(12) Patent Application Publication
(10) Pub. No.: US 2018/0020472 A1
(43) Pub. Date: Jan. 18, 2018

(54) HANDOVER MECHANISM WITH PRE-SCHEDULING CONSECUTIVE GRANTS AND PRE-CALCULATED TIMING ADVANCE

(71) Applicant: NOKIA TECHNOLOGIES OY, Espoo (FI)

(72) Inventors: Mu Rong LIN, Saratoga, CA (US); Jiyang SUN, Flower Mound, TX (US)

(21) Appl. No.: 15/210,503

(22) Filed: Jul. 14, 2016

(51) Int. Cl. H04W 72/14; H04W 72/04; H04W 36/08; H04W 74/08; H04W 36/00

(52) U.S. Cl. CPC H04W 72/14; H04W 74/08; H04W 36/0016; H04W 36/08; H04W 72/0446

(57) ABSTRACT

Various communication systems may benefit from mechanisms for transferring control over or communication with terminal devices. For example, certain wireless communication systems may benefit from a handover mechanism with pre-scheduling consecutive grants and pre calculated timing advance. A method can include receiving pre-scheduled uplink grants in a plurality of sub-frames for an incoming user equipment without random access channel The method can also include receiving a timing advance value or performing timing advance calculation for the incoming user equipment without random access channel The method can further include sending a plurality of duplicate messages within the plurality of sub-frames based on the received timing advance value or calculated timing advance.

### BACKGROUND

### Field

Various communication systems may benefit from mechanisms for transferring control over or communication with terminal devices. For example, certain wireless communication systems may benefit from a handover mechanism with pre-scheduling consecutive grants and pre-calculated timing advance.

### Description of the Related Art

Random access channel (RACH) based contention-free handover as designed in the third generation partnership project (3GPP) includes two steps. In the first step, a user equipment (UE) sends a preamble-index on physical random access channel (PRACH) to Target eNB. In the second step, the target eNB replies to the UE with an uplink grant and timing advance (TA). Only after these two steps, UE can start to send the first uplink packet.

This approach, however, may present a noticeable service interruption time. Moreover, this approach may provide congestion in the RACH, which can compound the noticeable service interruption time. Furthermore, this approach may lack the capability to provide priority mobility for some use cases, such as, for example, critical communication.

### SUMMARY

According to a first embodiment, a method can include receiving pre-scheduled uplink grants in a plurality of sub-frames for an incoming user equipment without random access channel. The method can also include receiving a timing advance value or performing timing advance calculation for the incoming user equipment without random access channel. The method can further include sending a plurality of duplicate messages within the plurality of sub-frames based on the received timing advance value or calculated timing advance.

According to a second embodiment, a method can include pre-scheduling uplink grants in a plurality of sub-frames for an incoming user equipment without random access channel. The method can also include performing timing advance calculation for the incoming user equipment without random access channel.

According to a third embodiment, a method can include determining that a user equipment is to be handed over from a source access node to a target access node. The method can also include switching the user equipment to semi-persistent scheduling based on the determination that the user equipment is to be handed over. The method can further include providing information regarding the semi-persistent scheduling to the target access node.

According to fourth through sixth embodiments, an apparatus can include means for performing the method according to the first through third embodiments respectively.

According to seventh through ninth embodiments, an apparatus can include at least one processor and at least one memory and computer program code. The at least one memory and the computer program code can be configured to, with the at least one processor, cause the apparatus at least to perform the method according to the first through third embodiments respectively.

According to tenth through twelfth embodiments, a computer program product may encode instructions for performing a process including the method according to the first through third embodiments respectively.

According to thirteenth through fifteenth embodiments, a non-transitory computer readable medium may encode instructions that, when executed in hardware, perform a process including the method according to the first through third embodiments respectively.

According to sixteenth and seventeenth embodiments, a system may include at least one apparatus according to each of the fourth through sixth embodiments or each of the seventh through ninth embodiments, in communication with one another, for example as shown in FIG. 1 or FIG. 6.

### BRIEF DESCRIPTION OF THE DRAWINGS

For proper understanding of the invention, reference should be made to the accompanying drawings, wherein:

FIG. 1 illustrates timing amounts that can be included in a calculation, according to certain embodiments.

FIG. 2 illustrates multiple consecutive uplink resources grants being scheduled, according to certain embodiments.

FIG. 3 illustrates a method of using observed time difference of arrival, according to certain embodiments.

FIG. 4 illustrates the use of multiple timing advance values applied to duplicate messages, according to certain embodiments.

FIG. 5 illustrates a typical handover situation, according to certain embodiments.

FIG. 6 illustrates a signal flow diagram, according to certain embodiments.

FIG. 7 illustrates a method according to certain embodiments.

FIG. 8 illustrates a system according to certain embodiments.

### DETAILED DESCRIPTION

It may be valuable for communication systems, such as critical communication described in 3GPP technical report (TR) 22.862 to limit the duration of service interruption for mission critical traffic and to support service continuity in a high mobility scenario.

Certain embodiments may provide a mechanism to skip a random access channel (RACH) procedure. The mechanism may help to identify how a target evolved Node B (eNB) can pre-schedule uplink grants for UE without RACH. Also, the mechanism may help to identify how a target eNB can do timing advance (TA) estimation for a UE without RACH.

Certain embodiments, therefore, may have two aspects. According to a first aspect there can be consideration of pre-scheduling uplink grants, and according to the second aspect there can be consideration of timing advance estimation. These aspects may be used separately or together, and certain benefits and/or advantages, as described below, may proceed from the synergies of using both aspects in combination.

According to the first aspect, a target eNB or other access node can pre-schedule consecutive uplink grants in sequential sub-frames for an incoming UE without RACH. The incoming UE can be the UE that is about to be handed over to the target eNB.

The target eNB can decide the time domain for the uplink resources, for example the future sub-frame ‘n+x’ for the UE. Here ‘n’ can refer to the time when target eNB receives an X2-Handover-request message from a source eNB or other access node, and ‘x’ can be the number of sub-frames of delay where the uplink grant will be scheduled for the incoming UE.

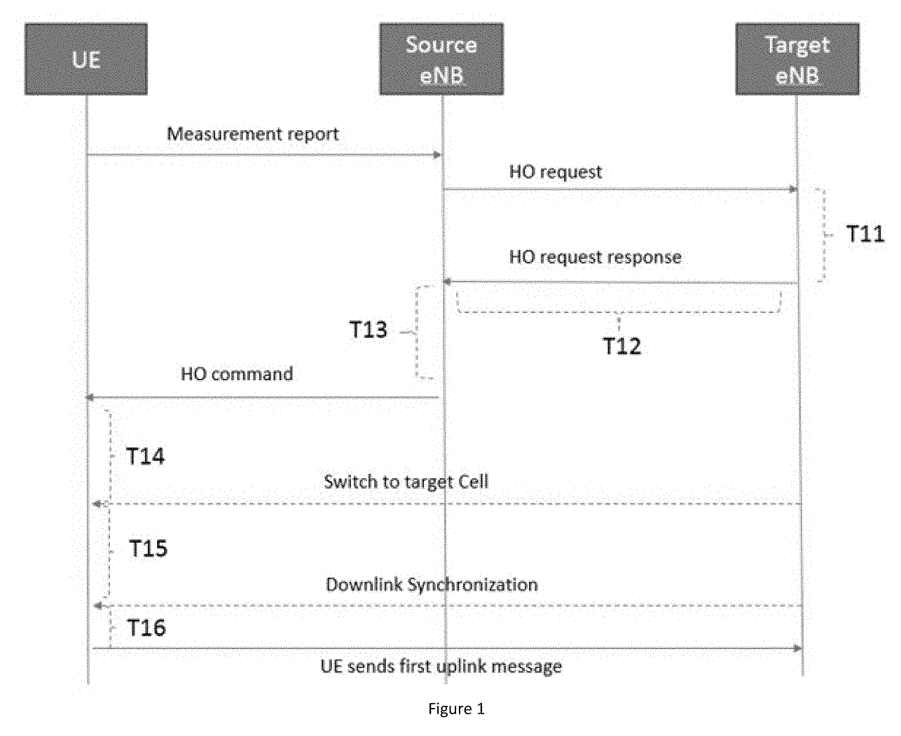

FIG. 1 illustrates timing amounts that can be included in a calculation, according to certain embodiments. The ‘x’ discussed above can be calculated as ‘x=T11+T12+T13+T14+T15+T16’, with the various T values shown in FIG. 1. T11 can refer to target eNB processing time after receiving an X2-Handover-request message. T12 can refer to a time to deliver an X2AP message from a target eNB to a source eNB. T13 can refer to a source eNB processing time after receiving an X2-Handover-request-response message. T14 can refer to a UE processing time after receiving an RRC-Handover-command T15 can refer to a UE processing time for downlink synchronization to a target eNB. T16 can refer to a UE preparation time before sending the first message to a target eNB.

The value of ‘T12’, a time to deliver an X2AP message between eNBs, can depend on latency of the Ethernet connection between the eNBs. In a lab test, T12 was about 3 milliseconds. In other implementations, T12 can be determined by eNB's historical data measurements. Thus, T12 may be determined with greater accuracy than simply relying on lab tests.

The sum of the remaining values (T11, T13, T14, T15, and T16) can be obtained from lab or field experiments. For example, the value of a total of 15 milliseconds may be a value based on a lab test result.

This value of ‘x’ may have some variations due to UE performance or eNB load. To deal with this variation, multiple consecutive uplink resources grants can be scheduled for the incoming UE. These may be presented as uplink sub-frame resources from ‘n+x’ to ‘n+x+m’.

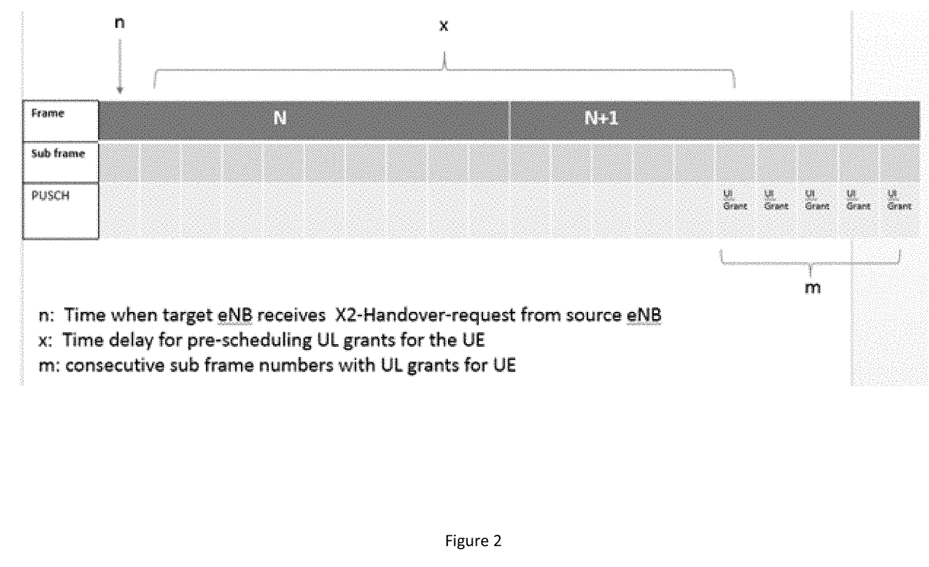

FIG. 2 illustrates multiple consecutive uplink resources grants being scheduled, according to certain embodiments. FIG. 2 shows example as ‘m=5’ in which case, UE will have 5 consecutive sub-frames for its first uplink data. In certain embodiments, a target eNB can adjust the value of ‘m’ based on real-time measurements and statistics.

According to the second aspect, there may be various methods for a target eNB to do timing advance calculation without RACH. Several options are set forth below, as examples and non-limiting illustrations.

According to a first option, a user equipment can estimate TA based on a downlink (DL) synchronization signal. The UE can be in uplink and downlink sync status in a source cell. Before handover to the target cell, the UE can read a target synchronization signal and calculate downlink time difference between source cell and target cell. The UE can use this difference as an uplink TA value for the target cell.

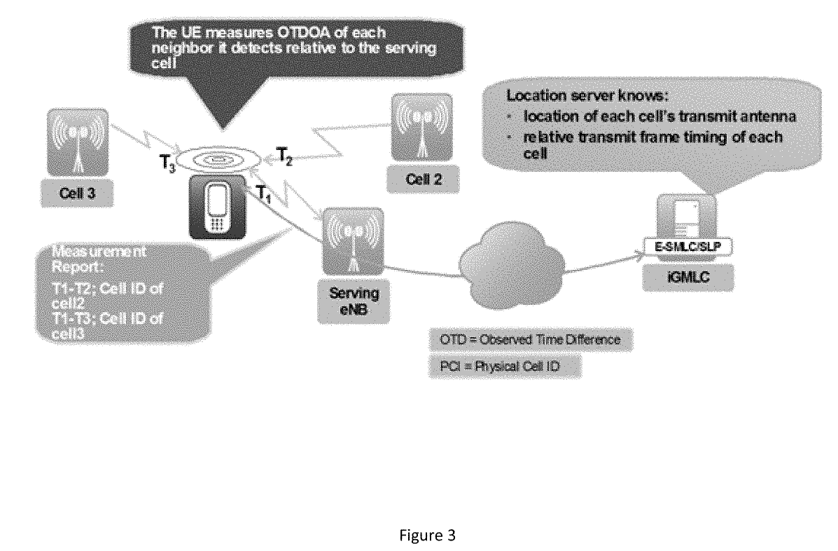

According to a second option, a user equipment can utilize an observed time difference of arrival (OTDOA). FIG. 3 illustrates a method of using observed time difference of arrival, according to certain embodiments.

The UE can measure OTDOA of each neighbor cell and detect a relative time difference between a serving cell and neighbor cells. As demonstrated in FIG. 3, for target cell as Cell2, UE can apply T1-T2 as TA value for its first message. The UE can also provide measurement reports via the serving eNB to a location server. The measurement reports can be identified by, for example, one or both physical cell identifiers.

Both the first and second options can rely on calculations that are based on downlink signal estimation. This may, in turn, rely on a hypothesis that downlink and uplink have the same time difference.

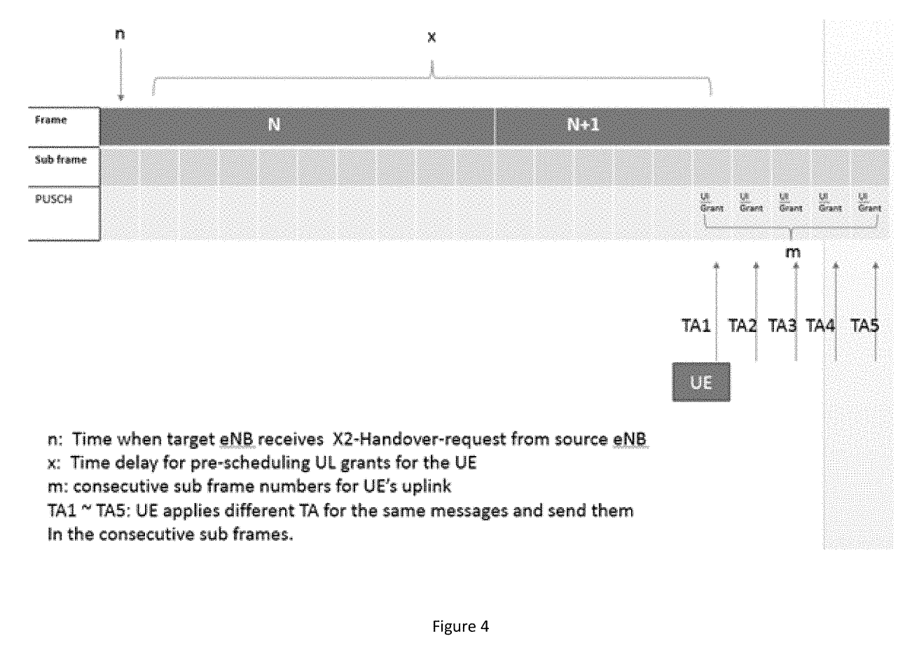

FIG. 4 illustrates the use of multiple timing advance values applied to duplicate messages, according to certain embodiments. To compensate for possible lack of TA accuracy, or for other purposes, consecutive uplink grants can be used in sequential sub-frames. For example, a UE can send duplicate messages within those consecutive sub-frames grant while applying different TA values for each message, as shown in FIG. 4. In FIG. 4, each of the duplicate messages has a different timing advance, although this is not mandatory. For example, each of the duplicate messages may have the same timing advance, or some may have the same and others may have different timing advance.

According to a third option, the target eNB can measure the incoming UE's uplink data before the UE's handover and can calculate TA for that UE. For example, after making a decision to start handover, the source eNB can changes the UE to semi-persistent scheduling (SPS) and can also include UE's SPS information in the X2-Handover-Request message.

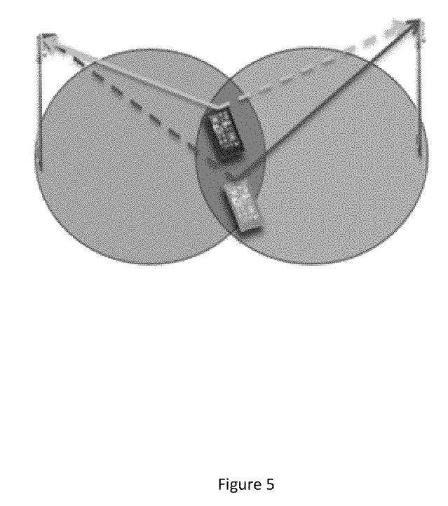

FIG. 5 illustrates a typical handover situation, according to certain embodiments. Handover may happen at a cell edge or boundary of two neighbor cells as shown in FIG. 5. Thus, a target eNB may be able to decode a UE's physical uplink shared channel (PUSCH) or physical uplink control channel (PUCCH) and calculate the timing offset accordingly. Because this TA calculation is based on the UE's uplink data, this may provide more accuracy than the first and second options described above.

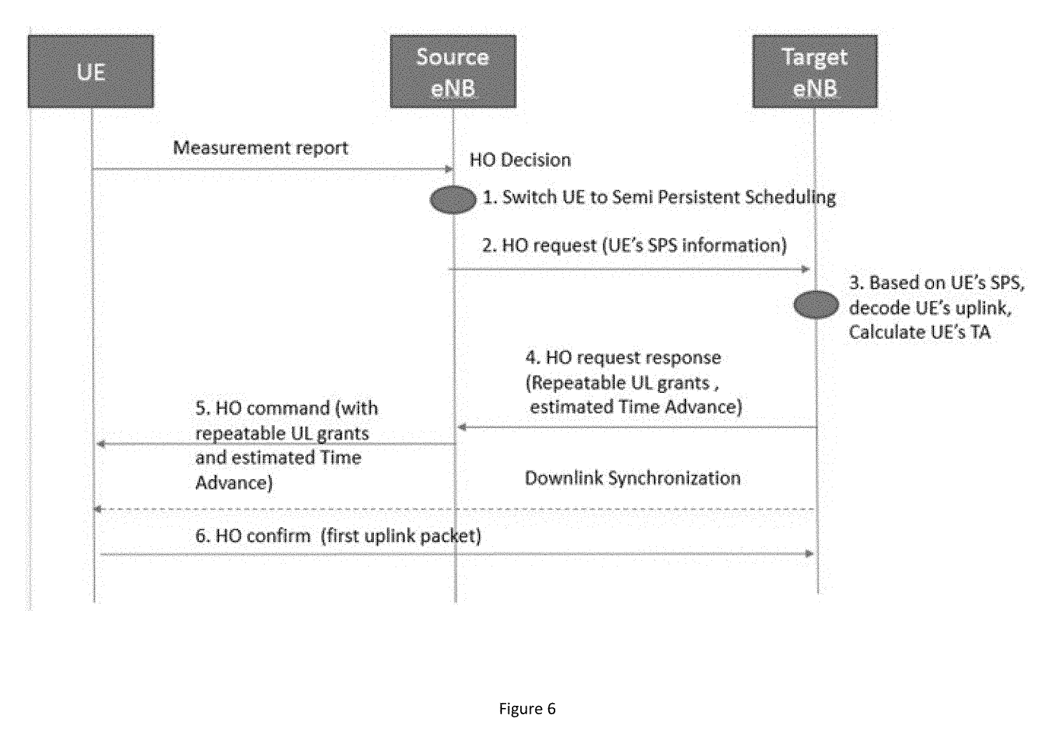

FIG. 6 illustrates a signal flow diagram, according to certain embodiments. Thus, overall procedures of certain embodiments are shown in FIG. 6.

As shown in FIG. 6, at 1 a source eNB, or other access node, can switch a UE to SPS once a handover decision is made. Then, at 2, the source eNB can send an X2-Handover-request message including the UE's SPS information.

At 3, the target eNB can do unlink pre-scheduling for the UE. Based on the UE's SPS information, the target eNB can decode the UE's uplink and calculate timing advance for the UE. The target eNB can schedule the unlink resources in time domain as ‘n+x’ to ‘n+x+m’, where ‘x’ corresponds to UL grant sub-frame delay and ‘m’ corresponds to a number of consecutive sub-frames granted for UE.

At 4, the target eNB can include UL grants and TA in the message X2-Handover-request-response to the source eNB. Then, at 5, the source eNB can forward these UL grants and TA to the UE in the message (rrcConnectionReconfiguration/Handover-command) The UE can then, at 6, apply this TA value and send message(s) within those UL grants to the target eNB without a random access channel procedure.

Thus, in certain embodiments, a source eNB can switch a UE to semi-persistent scheduling when a handover decision is made. The source eNB can include a UE's SPS information in X2-Handover-Request message.

The target eNB can provide pre-scheduling of consecutive uplink grants in sequential sub-frames, and output parameter (n, x, m), having the meanings described above. The target eNB can implement the method of TA calculation based on the third option described above. Thus, the target eNB can include parameters (n, x, m, TA) inside the X2-Handover-Response message. The source eNB can include those parameters (n, x, m, TA) inside message rrcConnectionReconfiguration, The UE can skip any RACH procedure. Moreover the UE can apply the TA and send a first uplink message within those uplink grants.

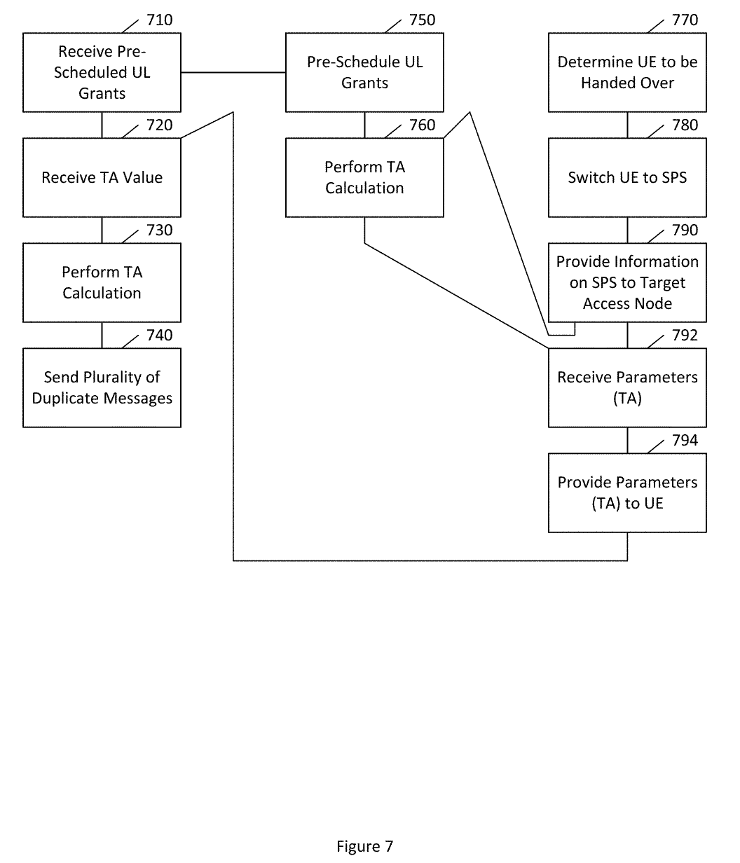

FIG. 7 illustrates a method according to certain embodiments. As shown in FIG. 7, a method can include, at 710, receiving pre-scheduled uplink grants in a plurality of sub-frames for an incoming user equipment without random access channel The method can also include, at 720, receiving a timing advance value or, at 730, performing timing advance calculation for the incoming user equipment without random access channel

The uplink grants can be consecutive uplink grants. The plurality of sub-frames can be sequential sub-frames. Examples of these features are illustrated in FIGS. 2 and 4.

The timing advance calculation can include estimating time advance based on a downlink synchronization signal or based on an observed time difference of arrival between signals. For example, the UE can obtain an observed time difference of arrival between signals by comparing the downlink from two neighbor cells, which arrive at different times. These approaches of basing the calculation on a downlink synchronization signal or of basing the calculation on an observed time difference of arrival between signals can correspond to the first and second options described above.

Alternatively, or in addition, the received timing advance can be based on measurements by a target access node of uplink data of the incoming user equipment. In other words, it possible for the UE to calculate TA information itself but also to receive TA information from another node.

The method can further include, at 740, sending a plurality of duplicate messages within the plurality of sub-frames grant while applying same or different timing advance values for each message of the duplicate messages.

The above features of the method may be performed by a user equipment. The following features of the method may be performed by network elements such as a target access node and a source access node.

The method can include, at 750, pre-scheduling uplink grants in a plurality of sub-frames for an incoming user equipment without random access channel The method can also include, at 760, performing timing advance calculation for the incoming user equipment without random access channel The timing advance can be calculated based on measurements by a target access node of uplink data of the incoming user equipment, for example as described above as the third option.

The above access node method features can be performed by a target access node. The following method features can be performed by a source access node. The method can include, at 770, determining that a user equipment is to be handed over from a source access node to a target access node. The method can also include, at 780, switching the user equipment to semi-persistent scheduling based on the determination that the user equipment is to be handed over. The method can further include, at 790, providing information regarding the semi-persistent scheduling to the target access node.

The method can additionally include, at 792, receiving parameters including time advance information of the user equipment from the target access node. The time advance information can include a timing offset or an actual timing advance value. Thus, there may be at least two different implementations. In a first implementation a delta TA can be provided as a timing offset and the UE can do some adjustment calculation, for example +3 or −3, or 2. In a second implementation, an actual TA value can be provided and the UE can apply this TA directly into an uplink message. The method can further include, at 794, providing the parameters to the user equipment.

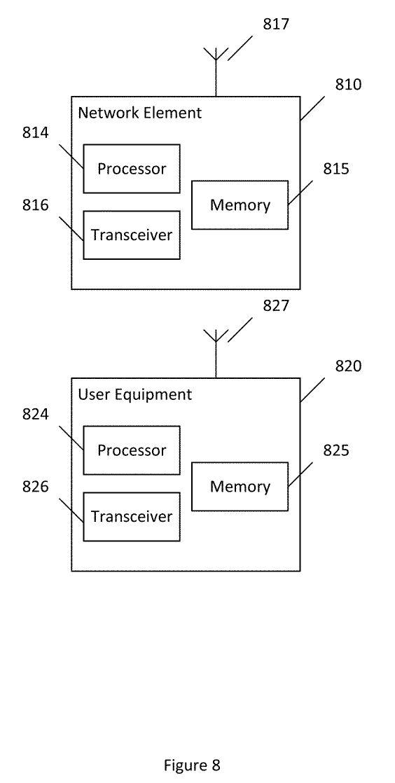

FIG. 8 illustrates a system according to certain embodiments of the invention. It should be understood that each block of the flowchart of FIG. 7 may be implemented by various means or their combinations, such as hardware, software, firmware, one or more processors and/or circuitry. In one embodiment, a system may include several devices, such as, for example, network element 810 and user equipment (UE) or user device 820. The system may include more than one UE 820 and more than one network element 810, although only one of each is shown for the purposes of illustration. A network element can be an access node, such as an access point, a base station, or an eNode B (eNB), or any other network element. There may be both a source eNB and a target eNB as described above, and each may be similarly configured, as handovers may occur to and from each eNB.

Each of these devices may include at least one processor or control unit or module, respectively indicated as 814 and 824. At least one memory may be provided in each device, and indicated as 815 and 825, respectively. The memory may include computer program instructions or computer code contained therein, for example for carrying out the embodiments described above. One or more transceiver 816 and 826 may be provided, and each device may also include an antenna, respectively illustrated as 817 and 827. Although only one antenna each is shown, many antennas and multiple antenna elements may be provided to each of the devices. Other configurations of these devices, for example, may be provided. For example, network element 810 and UE 820 may be additionally configured for wired communication, in addition to wireless communication, and in such a case antennas 817 and 827 may illustrate any form of communication hardware, without being limited to merely an antenna.

Transceivers 816 and 826 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner In other words, division of labor may vary case by case. One possible use is to make a network element to deliver local content. One or more functionalities may also be implemented as a virtual application that is provided as software that can run on a server.

A user device or user equipment 820 may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, vehicle, navigation unit provided with wireless communication capabilities or any combinations thereof The user device or user equipment 820 may be a sensor or smart meter, or other device that may usually be configured for a single location.

In an exemplifying embodiment, an apparatus, such as a node or user device, may include means for carrying out embodiments described above in relation to FIG. 6 or 7.

Processors 814 and 824 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof The processors may be implemented as a single controller, or a plurality of controllers or processors. Additionally, the processors may be implemented as a pool of processors in a local configuration, in a cloud configuration, or in a combination thereof

For firmware or software, the implementation may include modules or units of at least one chip set (e.g., procedures, functions, and so on). Memories 815 and 825 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 810 and/or UE 820, to perform any of the processes described above (see, for example, FIGS. 2 through 7). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 8 illustrates a system including a network element 810 and a UE 820, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

Certain embodiments may have various benefit and/or advantages. For example, certain embodiments may improve handover performance, for example shortening handover latency, reducing RACH congestion ratio, and providing priority mobility capability for some UEs under scenarios such as critical communication. Thus, for example, this mechanism can be applied to a critical communication scenario when some UE needs extreme high priority mobility support from network.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### LIST OF ABBREVIATIONS

eNB—Evolved Node B
3GPP—The 3rd Generation Partnership Project
UE—User Equipment
TA—Timing Advance
RACH—Random Access Procedure
OTDOA—Observed Time Difference of Arrival
UL—Uplink
DL—Downlink
PUCCH—Physical Uplink Control Channel
PUSCH—Physical Uplink Shared Channel

We claim:

1. An apparatus, comprising:
at least one processor; and
at least one memory including computer program code,
wherein the at least memory and computer program code are configured to, with the at least one processor, cause the apparatus at least to
receive pre-scheduled uplink grants in a plurality of sub-frames for an incoming user equipment without random access channel;
receive a timing advance value or performing timing advance calculation for the incoming user equipment without random access channel; and
send a plurality of duplicate messages within the plurality of sub-frames based on the received timing advance value or calculated timing advance.

2. The apparatus of claim 1, wherein the uplink grants comprise consecutive uplink grants.

3. The apparatus of claim 1, wherein the plurality of sub-frames comprise sequential sub-frames.

4. The apparatus of claim 1, wherein the timing advance calculation comprises estimating time advance based on a downlink synchronization signal.

5. The apparatus of claim 1, wherein the timing advance calculation comprises calculating based on an observed time difference of arrival between signals.

6. The apparatus of claim 1, wherein the received timing advance is based on measurements by a target access node of uplink data of the incoming user equipment.

7. The apparatus of claim 1, wherein the at least memory and computer program code are configured to, with the at least one processor, cause the apparatus at least to, when sending the plurality of duplicate messages within the plurality of sub-frames, apply different timing advance values for each message of the duplicate messages.

8. The apparatus of claim 1, wherein the at least memory and computer program code are configured to, with the at least one processor, cause the apparatus at least to, when sending the plurality of duplicate messages within the plurality of sub-frames, apply same timing advance values for each message of the duplicate messages.

9. An apparatus, comprising:
at least one processor; and
at least one memory including computer program code,
wherein the at least memory and computer program code are configured to, with the at least one processor, cause the apparatus at least to
pre-schedule uplink grants in a plurality of sub-frames for an incoming user equipment without random access channel; and
perform timing advance calculation for the incoming user equipment without random access channel.

10. The apparatus of claim 9, wherein the timing advance is calculated based on measurements by a target access node of uplink data of the incoming user equipment.

11. The apparatus of claim 9, wherein the uplink grants comprise consecutive uplink grants.

12. The apparatus of claim 9, wherein the plurality of sub-frames comprise sequential sub-frames.

13. The apparatus of claim 9, wherein the at least memory and computer program code are configured to, with the at least one processor, cause the apparatus at least to, receive and process at least one of a plurality of duplicate messages from the user equipment within the plurality of sub-frames.

14. The apparatus of claim 13, wherein different timing advance values are applied for each message of the duplicate messages.

15. The apparatus of claim 13, wherein same timing advance values are applied for each message of the duplicate messages.

16. An apparatus, comprising:
at least one processor; and
at least one memory including computer program code,
wherein the at least memory and computer program code are configured to, with the at least one processor, cause the apparatus at least to
determine that a user equipment is to be handed over from a source access node to a target access node;
switch the user equipment to semi-persistent scheduling based on the determination that the user equipment is to be handed over; and
provide information regarding the semi-persistent scheduling to the target access node.

17. The apparatus of claim 16, wherein the at least memory and computer program code are configured to, with the at least one processor, cause the apparatus at least to:
receive parameters including time advance information of the user equipment from the target access node; and
provide the parameters to the user equipment.

18. The apparatus of claim 17, wherein the time advance information comprises at least one a timing offset or at least one actual timing advance value.

19. The apparatus of claim 17, wherein the parameters are received in a handover response message from the target access node.

20. The apparatus of claim 16, wherein the semi-persistent scheduling information is provided in a handover request message to the target access node.
